(19) United States
(12) Patent Application Publication
(10) Pub. No.: US 2026/0134629 A1
(43) Pub. Date: May 14, 2026

(54) SYSTEMS AND METHODS FOR INFERRING OBJECT FROM AERIAL IMAGERY

(71) Applicant: NBCUniversal Media, LLC, New York, NY (US)

(72) Inventors: Bryant J. Curto, Philadelphia, PA (US); Thomas Daniel Dickerson, Bristol, VT (US); Daniel Christopher Ritchie, Providence, RI (US)

(21) Appl. No.: 19/440,397

(22) Filed: Jan. 5, 2026

Related U.S. Application Data
(63) Continuation of application No. 17/909,119.
(60) Provisional application No. 62/985,156, filed on Mar. 4, 2020.

(51) Int. Cl. G06T 17/20; B29C 64/386; B33Y 50/00; G06T 15/10

(52) U.S. Cl. CPC G06T 17/20; B29C 64/386; B33Y 50/00; G06T 15/10; G06T 2200/08

(57) ABSTRACT

Implementations described and claimed herein provide systems and methods for object modeling. In one implementation, input imagery of a real-world object is obtained at an object modeling system. The input imagery is captured using an imaging system from a designated viewing angle. A 3D model of the real-world object is generated based on the input imagery using the object modeling system. The 3D model is generated based on a plurality of stages corresponding to a sequence of polygons stacked in a direction corresponding to the designated viewing angle. The 3D model is output for presentation using a presentation system.

### CROSS-REFERENCE TO RELATED APPLICATIONS

The present application is a continuation of Ser. No. 17/909,119, filed Sep. 2, 2022, which is a national stage filing under 35 § U.S.C. 371 of international PCT application PCT/US/2021/020931, filed Mar. 4, 2021, which claims priority under 35 U.S.C. § 119(e) to U.S. Provisional Patent Application No. 62/985,156, filed Mar. 4, 2020, each of which is herein incorporated by reference in its entirety.

### FIELD

Aspects of the present disclosure relate generally to systems and methods for inferring an object and more particularly to generating a three-dimensional model of an object from imagery from a viewing angle via sequential extrusion of polygonal stages.

### BACKGROUND

Three-dimensional (3D) models of real world objects, such as buildings, are utilized in a variety of contexts, such as urban planning, natural disaster management, emergency response, personnel training, architectural design and visualization, anthropology, autonomous vehicle navigation, gaming, virtual reality, and more. In reconstructing a 3D model of an object, low-level aspects, such as planar patches, may be used to infer the presence of object geometry, working from the bottom up to complete the object geometry. While such an approach may reproduce fine-scale detail in observed data, the output often exhibits considerable artifacts when attempting to fit to noise in the observed data because the output of such approaches is not constrained to any existing model class. As such, if the input data contains any holes, the 3D model will also contain holes when using such approaches. On the other hand, observed data may be fitted to a high-level probabilistic and/or parametric model of an object (often represented as a grammar) via Bayesian inference. Such an approach may produce artifact-free geometry, but the limited expressiveness of the model class may result in outputs that are significantly different from the observed data. It is with these observations in mind, among others, that various aspects of the present disclosure were conceived and developed.

### SUMMARY

Implementations described and claimed herein address the foregoing problems by providing systems and methods for inferring an object. In one implementation,

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting

### BRIEF DESCRIPTION OF THE DRAWINGS

FIG. 1 illustrates an example object inference system.

FIG. 2 shows an example machine learning pipeline of an object modeling system of the object inference system.

FIG. 3 depicts various example representations of object masses comprised of vertically-extruded polygons.

FIG. 4 shows various examples of component attributes.

FIG. 5 illustrates an example decomposition of an object geometry into vertical stages.

FIG. 6 shows an example visualization of stages of an object as binary mask images.

FIG. 7 illustrates example vectorization of each stage component.

FIG. 8 shows an example network environment that may implement the object inference system.

FIG. 9 is an example computing system that may implement various systems and methods discussed herein.

### DETAILED DESCRIPTION

Aspects of the presently disclosed technology relate to systems and methods for inferring real world objects, such as buildings. Generally, an object inference system includes an imaging system, an object modeling system, and a presentation system. The input system captures input imagery of an object from a viewing angle (e.g., a plan view via an aerial perspective) using one or more sensors. The object modeling system utilizes the input imagery to generate a 3D model of the object using machine learning, and the presentation system presents the 3D model in a variety of manners, including displaying, presenting, overlaying, and/or manufacturing (e.g., via additive printing).

In one aspect, the object modeling system generates 3D models of objects, such as buildings, given input imagery obtained from a designated viewing angle, for example using only orthoimagery obtained via aerial survey. The object modeling system utilizes a machine learning architecture that defines a procedural model class for representing objects as a collection of vertically-extruded polygons, and each polygon may be terminated by an attribute geometry (e.g., a non-flat geometry) belonging to one of a finite set of attribute types and parameters. Each of the polygons defining the object mass may be defined by an arbitrary closed curve, giving the model a vast output space that can closely to fit to many types of real-world objects.

Given the observed input imagery of the real-world object, the object modeling system performs inference in this model space using the machine learning architecture, such as a neural network architecture. The object modeling system iteratively predicts the set of extruded polygons which comprise the object, given the input imagery and polygons predicted thus far. To make the decomposition unambiguous, all objects are normalized to use a plurality of stages corresponding to a vertically-stacked sequence of polygons. In this manner, the object modeling system may generally reconstruct 3D objects in a bottom-to-top, layerwise fashion. The object modeling system may further predict a presence, type, and parameter of attribute geometries atop the stages to form a realistic 3D model of the object.

Generally, the presently disclosed technology generates realistic 3D models of real-world objects using a machine learning architecture and input imagery for presentation. Rather than producing a heavily oversmoothed result if the input imagery is not dense and noise-free like some conventional methods or making assumptions about a type of the object for fitting to predefined models, the presently disclosed technology provides an inference pipeline for sequentially predicting object mass stages, with each prediction conditioned on the preceding predicted stages. The presently disclosed technology increases computational efficiency, while decreasing input data type and size. For example, a 3D model of any object may be generated in milliseconds using only input imagery captured from a single viewing angle. Other benefits will be readily apparent from the present disclosure. Further, the example implementations described herein reference buildings and input imagery including orthoimagery obtained via aerial survey. However, it will be appreciated by those skilled in the art that the presently disclosed technology is applicable to other types of objects and other viewing angles, input imagery, and imaging systems, sensors, and techniques. Further, the example implementations described herein reference machine learning utilizing neural networks. It will similarly be appreciated by those skilled in the art that other types of machine learning architectures, algorithms, training data, and techniques may be utilized to generate realistic 3D models of objects according to the presently disclosed technology.

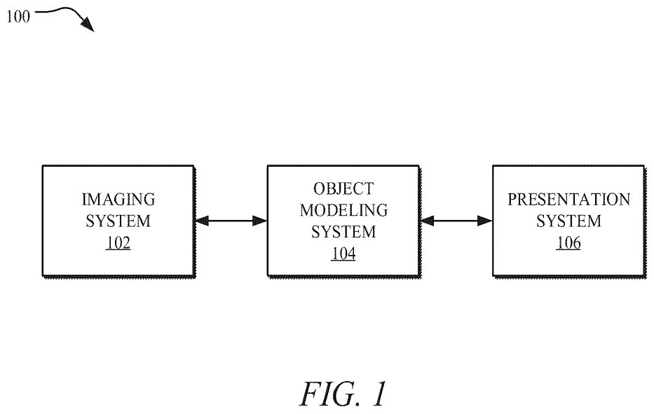

To begin a detailed description of an example object inference system 100 for generating a 3D model of a real-world object, reference is made to FIG. 1. The real-world object may be any type of object located in a variety of different environments and contexts. For example, the real-world object may be a building. In one implementation, the object inference system 100 includes an imaging system 102, an object modeling system 104, and a presentation system 106.

The imaging system 102 may include one or more sensors, such as a camera (e.g., red-green-blue (RGB), infrared, monochromatic, etc.), depth sensor, and/or the like, configured to capture input imagery of the real-world object. In one implementation, the imaging system 102 captures the input imagery from a designated viewing angle (e.g., top, bottom, side, back, front, perspective, etc.). For example, the input imagery may be orthoimagery captured using the imaging system 102 during an aerial survey (e.g., via satellite, drone, aircraft, etc.). The orthoimagery may be captured from a single viewing angle, such as a plan view via an aerial perspective.

In one implementation, the imaging system 102 captures the input imagery in the form of point cloud data, raster data, and/or other auxiliary data. The point cloud data may be captured with the imaging system 102 using LIDAR, photogrammetry, synthetic aperture radar (SAR), and/or the like. The auxiliary data, such as two-dimensional (2D) images, geospatial data (e.g., geographic information system (GIS) data), known object boundaries (e.g., property lines, building descriptions, etc.), planning data (e.g., zoning data, urban planning data, etc.) and/or the like may be used to provide context cues about the point cloud data and the corresponding real-world object and surrounding environment (e.g., whether a building is a commercial building or residential building). The auxiliary data may be captured using the imaging system 102 and/or obtained from other sources. In one example, the auxiliary data includes high resolution raster data or similar 2D images in the visible spectrum and showing optical characteristics of the various shapes of the real-world object. Similarly, GIS datasets of 2D vector data may be rasterized to provide context cues. The auxiliary data may be captured from the designated viewing angle from which the point cloud was captured.

The object modeling system 104 obtains the input imagery, including the point cloud data as well as any auxiliary data, corresponding to the real-world object. The object modeling system 104 may obtain the input imagery in a variety of manners, including, but not limited to, over a network, via memory (e.g., a database, portable storage device, etc.), via wired or wireless connection with the imaging system 102, and/or the like. The object modeling system 104 renders the input imagery into image space from a single view, which may be the same as the designated viewing angle at which the input imagery was captured. In one implementation, using the input imagery, the object modeling system 104 generates a canvas representing a height of the real-world object and predicts an outline of a shape of the real-world object at a base layer of the object mass. The object modeling system 104 predicts a height of a first stage corresponding to the base layer, as well as any other attribute governing its shape, including whether the first stage has any non-flat geometries. Stated differently, the object modeling system 104 generates a footprint, extrudes it in a prismatic shape according to a predicted height, and predicts any non-flat geometry that should be reconstructed over the prismatic shape. Each stage corresponding to the object mass is generated through rendering of an extruded footprint and prediction of non-flat geometry or other attributes.

The object modeling system 104 may include a machine learning architecture providing an object inference pipeline for generating the 3D model of the real-world object. The object inference pipeline may be trained in a variety of manners using different training datasets. For example, the training datasets may include ground truth data representing different shapes, which are decomposed into layers and parameters describing each layer. For example, the 3D geometry of the shape may be decomposed into portions that each a contains a flat geometry from a base layer to a height corresponding to one stage with any non-flat geometry stacked on the flat geometry. The training data may include automatic or manual annotations to the ground truth data. Additionally, the training data may include updates to the ground truth data where an output of the inference pipeline more closely matches the real-world object. In this manner, the object inference pipeline may utilize a weak supervision, imitation learning, or similar learning techniques.

In one implementation, the object inference pipeline of the object modeling system 104 uses a convolutional neural network (CNN) pipeline to generate a 3D model of a real-world object by using point cloud data, raster data, and any other input imagery to generate a footprint extruded to a predicted height of the object through a plurality of layered stages and including a prediction of non-flat geometry or other object attributes. However, various machine learning techniques and architectures may be used to render the 3D model in a variety of manners. As a few additional non-limiting examples, a predicted input to surface function may be used to find a zero level set to describe boundaries, a deformable mesh having a lower resolution where vertices are moved to match object edges, a transformer model, and/or the like may be used to generate a footprint of the object with attribute predictions using input imagery for generating a 3D model of the object.

The object modeling system 104 outputs the 3D model of the real-world object to the presentation system 106. Prior to output, the object modeling system 104 may refine the 3D model further through post-processing. For example, the 3D model may be refined with input imagery captured from viewing angles that are different from the designated viewing angle, add additional detail to the 3D model, modify the 3D model based a relationship between the stages to form an estimated 3D model that represents a variation of the real-world object differing from its current state, and/or the like. For example, the real-world object may be a building foundation of a new building. The object modeling system 104 may initially generate a 3D model of the building foundation and refine the 3D model to generate an estimated 3D model providing a visualization of what the building could look like when completed. As another example, the real-world object may be building ruins. The object modeling system 104 may initially generate a 3D model of the building ruins and refine the 3D model to generate an estimated 3D model providing a visualization of what the building used to look like when built.

The presentation system 106 may present the 3D model of the real-world object in a variety of manners. For example the presentation system 106 may display the 3D model using a display screen, a wearable device, a heads-up display, a projection system, and/or the like. The 3D model may be displayed as virtual reality or augmented reality overlaid on a real-world view (with or without the real-world view being visible). Additionally, the presentation system 106 may include an additive manufacturing system configured to manufacture a physical 3D model of the real-world object using the 3D model. The 3D model may be used in a variety of contexts, such as urban planning, natural disaster management, emergency response, personnel training, architectural design and visualization, anthropology, autonomous vehicle navigation, gaming, virtual reality, and more, providing a missing link between data acquisition and data presentation.

In one example, the real-world object is a building. In one implementation, the object modeling system 104 represents the building as a collection of vertically-extruded polygons, where each polygon may be terminated by a roof belonging to one of a finite set of roof types. Each of the polygons which defines the building mass may be defined by an arbitrary closed curve, giving the 3D model a vast output space that can closely to fit to many types of real-world buildings. Given the input imagery as observed aerial imagery of the real-world building, the object modeling system 104 performs inference in the model space via neural networks. The neural network of the object modeling system 104 iteratively predicts the set of extruded polygons comprising the building, given the input imagery and polygons predicted thus far. To make the decomposition unambiguous, the object modeling system 104 may normalize all buildings to use a vertically-stacked sequence of polygons defining stages. The object modeling system 104 predicts a presence, a type, and parameters of roof geometries atop these stages. Overall, the object modeling system 104 faithfully reconstructs a variety of building shapes, both urban and residential, as well as both conventional and unconventional. The object modeling system 104 provides a stage-based representation for the building through a decomposition of the building into printable stages and infers sequences of print stages given input aerial imagery.

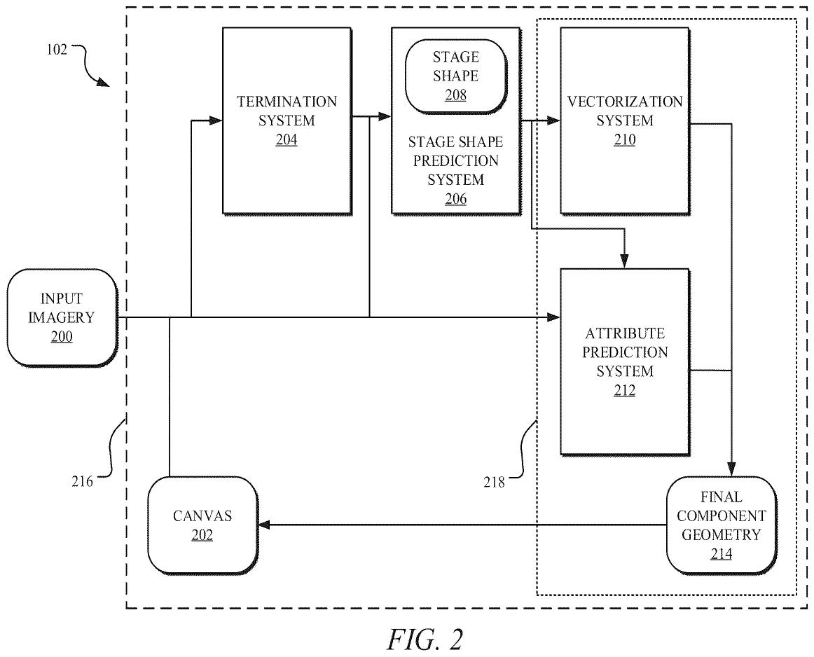

FIG. 2 shows an example machine learning pipeline of the object modeling system 104 configured to generate a 3D model of a real-world object from input imagery 200. In one implementation, the machine learning pipeline is an object inference pipeline including one or more neural networks, such as one or more CNNs. The object inference pipeline includes a termination system 204, a stage shape prediction system 206, a vectorization system 210, and an attribute prediction system 212. The various components 204, 206, 210, and 212 of the object inference pipeline may be individual machine learning components that are separately trained, combined together and trained end-to-end, or some combination thereof.

Referring to FIGS. 2-7 and taking a building as an example of a real-world object, in one implementation, the object modeling system 104 is trained using training data including representations of 3D buildings and aerial imagery and building geometries. The buildings are decomposed into vertically-extruded stages, so that they can be used as training data for the stage-prediction inference network of the object modeling system 104.

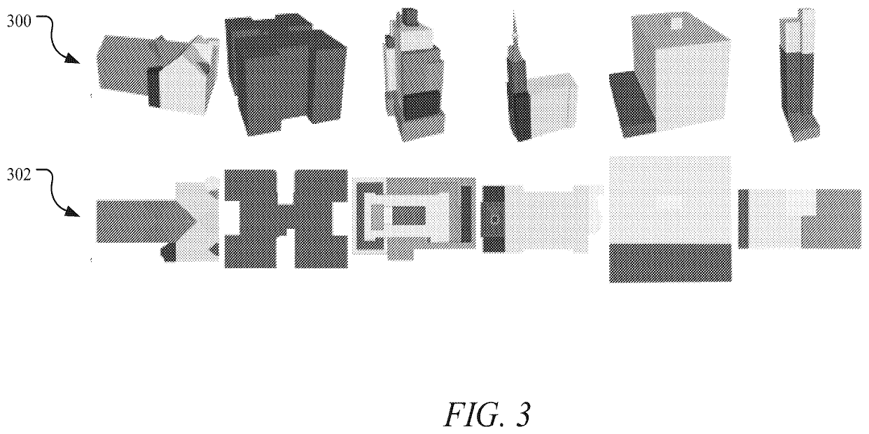

In one implementation, the representation of the 3D buildings in the training data are flexible enough to represent a wide variety of buildings. More particularly, the representations are not specialized to one semantic category of building (e.g. urban vs. residential) and instead include a variety of building categories. On the other hand, the representations are restricted enough that the neural network of the object modeling system 104 can learn to generate 3D models of such buildings reliably, i.e. without considerable artifacts. Finally, the training data includes a large number of 3D buildings. The representation of the training data defines a mass of a building via one or more vertically extruded polygons. For example, as shown in FIG. 3, which provides an oblique view 300 and a top view 302 of various building masses, the buildings are comprised of a collection of vertically-extruded polygons. Each of the individual polygons are represented in FIG. 3 in different color shades.

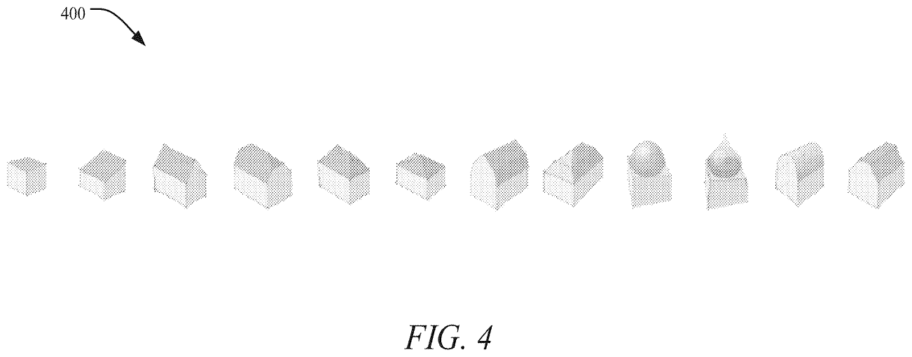

However, as can be understood from FIG. 3, while extruded polygons are expressive, they cannot model the tapering and joining that occurs when a building mass terminates in a roof or similar non-flat geometry. As such, the object modeling system 104 tags any polygon with a “roof” or similar attribute specifying the type of roof or other non-flat geometry which sits atop that polygon. FIG. 4 illustrates a visualization 400 of various roof types, which may include, without limitation, flat, skillion, gabled, half-hipped, hipped, pyramidal, gambrel, mansard, dome, onion, round, saltbox, and/or the like. In addition to discrete roof type, each roof has two parameters, controlling the roof's height and orientation. This representation is not domain-specific, so it can be used for different types of buildings. By restricting the training data to extruded polygons and predefined roof types, the output space of the model is constrained, such that so that the neural network of the object modeling system 104 tasked with learning to generate such outputs refrains from producing arbitrarily noisy geometry.

In one implementation, the representation of the training data composes buildings out of arbitrary unions of polyhedra, such that there may be many possible ways to produce the same geometry (i.e. many input shapes give rise to the same output shape under Boolean union). To eliminate this ambiguity and simplify inference, all buildings may be normalized by decomposing them into a series of vertically-stacked stages.

The training data may include aerial orthoimagery for real-world buildings, include infrared data in addition to standard red/green/blue channels. In one example, the aerial orthoimagery has a spatial resolution of approximately 15 cm/pixel. The input imagery includes a point cloud, such as a LIDAR point cloud. As an example, the LIDAR point cloud may have a nominal pulse spacing of 0.7 m (or roughly 2 samples/meter2), which is rasterized to a 15 cm/pixel height map using nearest-neighbor upsampling. The images may be tiled into chunks which can reasonably fit into memory, and image regions which cross tile boundaries may be extracted.

Vector descriptions of building footprints may be used to extract image patches representing a single building (with a small amount of padding for context), as well as to generate mask images (i.e. where the interior of the footprint is 1 and the exterior is 0). Footprints may be obtained from GIS datasets or by applying a standalone image segmentation procedure to the same source imagery. Extracted single-building images may be transformed, so that the horizontal axis is aligned with the first principal component of the building footprint, thereby making the dataset invariant to rotational symmetries.

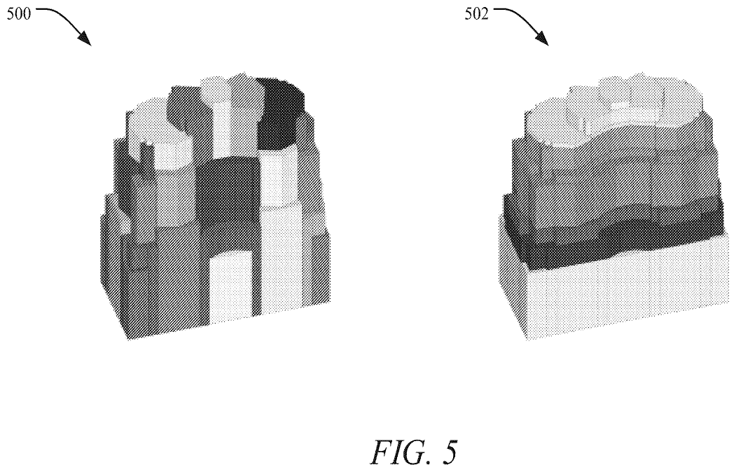

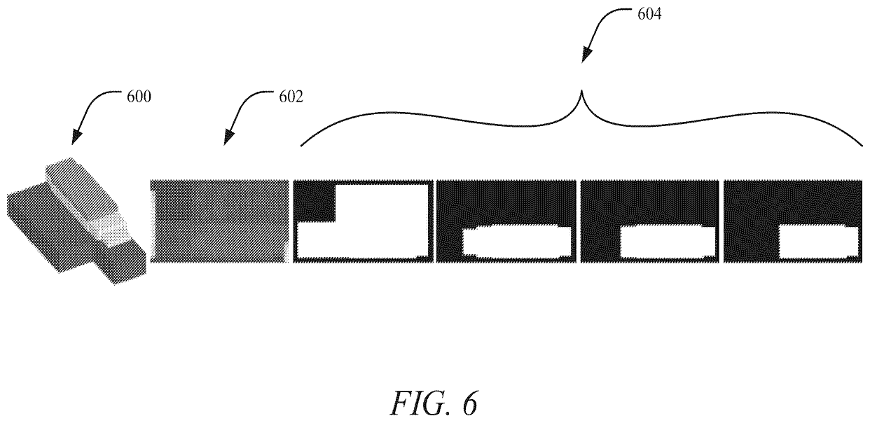

Using the building representation, there are many ways to combine extruded polygons to produce the same building mass. Some of these combinations cannot be inferred from aerial imagery, since they involve overlapping geometry that would be occluded by higher-up geometry. To eliminate this ambiguity, and to normalize all building geometry into a form that can be inferred from an aerial view, the object modeling system 104 converts all buildings in the training dataset into a sequence of disjointed vertical stages. The building can then be reconstructed via stacking these stages on top of one another in sequence. In conducting building normalization, the object modeling system 104 may use a scanline algorithm for rasterizing polygons, adapted to three dimensions. Scanning from the bottom of the building towards the top, parts with overlapping vertical extents are combined into a single part, cutting the existing parts in the x-y plane whenever one part starts or begins. The object modeling system 104 ensures that parts are only combined if doing so will not produce incorrect roof geometry and applies post-processing to recombine vertically adjacent parts with identical footprints. FIG. 5 illustrates the effect of this procedure in 3D. More particularly, FIG. 5 shows a decomposition of an original building geometry 500 into a sequence 502 of vertical stages. Different extruded polygons are illustrated in FIG. 5 in different color shades. FIG. 6 shows an example of converting such stages into binary mask images for training the object inference pipeline of the object modeling system 104.

Referring to FIG. 2, the object modeling system 104 iteratively infers the vertical stages that make up a building. The object inference pipeline of the object modeling system 104 obtains the input imagery 200 captured from a designated viewing angle, which may include aerial orthoimagery of a building (top-down images) and produce a 3D building in the representation. The object inference pipeline of the object modeling system 104 thus infers 3D buildings from aerial imagery. The object modeling system 104 iteratively infers the shapes of the vertically-extruded polygonal stages that make up the building using an image-to-image translation network. The outputs of the network are vectorized and combined with predicted attributes, such as roof types and heights to convert them to a polygonal mesh.

In one implementation, the input imagery 200 includes at least RGBD channels. For example, the input imagery 200 may be captured by a calibrated sensor package of the imaging system 102 containing at least an RGB camera and a LiDAR scanner. However, it will be appreciated that the object modeling system 104 may easily accommodate additional input channels which may be available in some datasets, such as infrared. Rather than attempt to perform the inference using bottom-up geometric heuristics or top-down Bayesian model fitting, the object modeling system 104 utilizes a data-driven approach by training neural networks to output 3D buildings using the input imagery 200.

In one implementation, given the input imagery 200, the object modeling system 104 infers the underlying 3D building by iteratively predicting the vertically-extruded stages which compose the 3D building. Through this iterative process, the object modeling system 104 maintains a record in the form of a canvas 202 of all the stages predicted, which is used to condition the operation of learning-based systems. Each iteration of the inference process invokes several such system. The termination system 204 uses a CNN to determine whether to continue inferring more stages. Assuming this determination returns true, the stage shape prediction system 206 uses a fully-convolutional image-to-image translation network to predict a raster mask of the next stage's shape. Each stage may contain multiple connected components of geometry. For each such component, the vectorization system 210 converts the raster mask for that component into a polygonal representation via a vectorization process and the attribute prediction system 212 predicts the type of roof (if any) sitting atop that component as well as various continuous attributes of the component, such as its height. The predicted attributes are used to procedurally extrude the vectorized polygon and add roof geometry to it, resulting in a final geometry 214, such as a watertight mesh, which is merged into the canvas 202 for the start of the next iteration. A portion 216 of the object inference pipeline is repeatable until all stages are inferred, and another portion 218 of the object inference pipeline is performed for each stage component.

The entire process terminates when the termination system 204 predicts that no more stages should be inferred. More particularly, the iterative, autoregressive inference procedure of the object modeling system 104 determines when to stop inferring new stages using the termination system 204. In one implementation, the termination system 204 utilizes a CNN that ingests the input imagery 200 and the canvas 202 (concatenated channel-wise) and outputs a probability of continuing. For example, the termination system 204 may use a ResNet-34 architecture, trained using binary cross entropy. Even when well-trained, the termination system 204 may occasionally produce an incorrect output, where the termination system 204 may decide to continue the process when there is no more underlying stage geometry to predict. To help recover from such scenarios, the termination system 204 includes additional termination conditions. Such additional termination conditions may include terminating if: the stage shape prediction module predicts an empty image (i.e. no new stage footprint polygons); the attribute prediction module predicts zero height for all components of the next predicted stage; and/or the like.

In one implementation, the stage shape prediction system 204 continues the process in the object inference pipeline if the termination system 202 decides to continue adding stages. The stage shape prediction system 204 uses a fully convolutional image-to-image translation network to produce the stage shape 206 of the next stage, conditioned on the input imagery 200 and the building geometry predicted thus far in the canvas 202. Thus, the stage shape prediction system 204 fuses different sources of information available in the input imagery 200 to make the best possible prediction, for example as depth, RGB, and other channels can carry complementary cues about building shape.

To perform the image-to-image translation, in one implementation, the stage shape prediction system 204 uses a fully convolutional generator architecture G. As an example, the input x to G may be an 8-channel image consisting of the input aerial RGB, depth, and infrared imagery (5 channels), a mask for the building footprint (1 channel), a mask plus depth image for all previous predicted stages (2 channels), and a mask image for the most recently predicted previous stage (1 channel). The output y of G in this example is a 2-channel image consisting of a binary mask y″ for the next stage's shape (1 channel) and a binary mask y for the next stage's outline (1 channel). The outline disambiguates between cases in which two building components are adjacent and would appear as one contiguous piece of geometry without a separate outline prediction. The stage shape prediction system 204 may be trained by combining a reconstruction loss, an adversarial loss L_{D} induced by a multi-scale discriminator D, and a feature matching loss L_{FM}. For reconstructing the building shape output channel, the stage shape prediction system 204 uses a standard binary cross-entropy loss L_{BCE}. For reconstructing the building outline channel, the BCE loss may be insufficient, as the stage shape prediction system 204 falls into the local minimum of outputting zero for all pixels. Instead, the stage shape prediction system 204 uses a loss which is based on a continuous relaxation of precision and recall:

$${ℒ}_{PR} ( {y}^{□} , {\hat{y}}^{□} ) = {ℒ}_{P} + {ℒ}_{R}$$

$${ℒ}_{P} = \frac{{\sum }_{i , j} {y}_{i , j}^{□} \cdot \vert {y}_{i , j}^{□} - {\hat{y}}_{i , j}^{□} \vert}{{\sum }_{i , j} {y}_{i , j}^{□}}$$

$${ℒ}_{R} = \frac{{\sum }_{i , j} {\hat{y}}_{i , j}^{□} \cdot \vert {y}_{i , j}^{□} - {\hat{y}}_{i , j}^{□} \vert}{{\sum }_{i , j} {\hat{y}}_{i , j}^{□}}$$

Essentially, the AP term says “generated nonzero pixels must match the target,” while the AR term says “target nonzero pixels must match the generator.” The overall loss used to train the model of the stage shape prediction system 204 is then:

$$ℒ ( y , \hat{y} ) = {λ}_{1} {ℒ}_{BCE} ( {y}^{■} , {\hat{y}}^{■} ) + {λ}_{2} {ℒ}_{PR} ( {y}^{□} , {\hat{y}}^{□} ) + {λ}_{3} {ℒ}_{D} ( y , \hat{y} ) + {λ}_{4} {ℒ}_{FM} ( y , \hat{y} )$$

In one example, the values are set as:

$${λ}_{1} = 1 , {λ}_{2} = 1 , {λ}_{3} = {10}^{- 2} , {λ}_{4} = {10}^{- 3} \vert$$

The stage shape prediction system 204 computes the individual building components of the predicted stage by subtracting the outline mask from the shape mask and finding connected components in the resulting image.

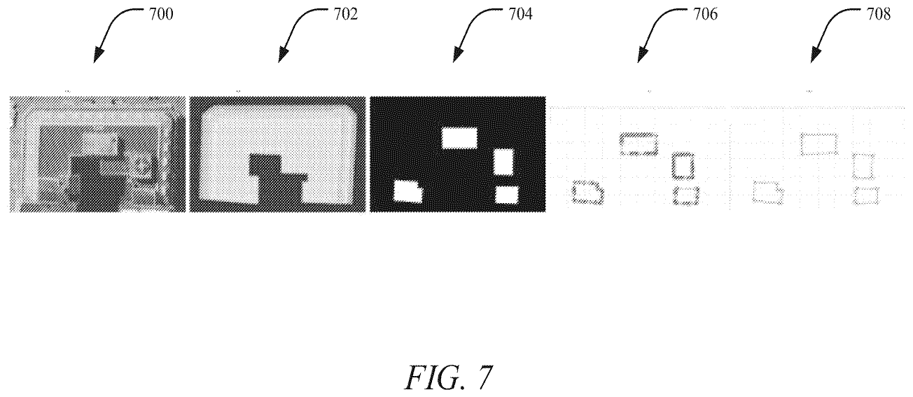

In one implementation, given each connected component of the predicted next stage, the vectorization system 210 converts it into a polygon which will serve as the footprint for the new geometry to be added to the predicted 3D building. The vectorization system 210 converts the fixed-resolution raster output of the image-to-image translator of the stage shape prediction system 204 into an infinite-resolution parametric representation, and the vectorization system 210 serves to smooth out artifacts that may result from imperfect network predictions. For example, FIG. 7 shows the vectorization approach of the vectorization system 210. First, the vectorization system 210 creates an initial polygon by taking the union of squares formed the nonzero-valued pixels in the binary mask image. Next, the vectorization system 210 runs a polygon simplification algorithm to reduce the complexity of the polygon. A tolerance used allows for a diagonal line in the output image to be represented with a single edge. Stated differently, the vectorization system 210 takes the raster image output of the image-to-image translation network of the stage shape prediction system 204, converts the raster image output to an overly-detailed polygon with one vertex per boundary pixel, and then simplifies the polygon to obtain the final footprint geometry 214 of each of the next stage's components. FIG. 7 illustrates an example of the vectorization process of the vectorization system 210, including an input RGB image 700, an input canvas 702, a raster image 704, a polygon 706, and a simplified polygon 708 for forming the final footprint geometry 214.

Given the polygonal footprint of each component of the next predicted stage, the attribute prediction system 212 infers the remaining attributes of the component to convert it into a polygonal mesh for the final component geometry 214 for providing to the canvas 202 to form the 3D model of the building. For example, the attributes may include, without limitation: height corresponding to the vertical distance from the component footprint to the bottom of the roof; roof type corresponding to one of the discrete roof types, for example, those shown in FIG. 4; roof height corresponding to the vertical distance from the bottom of the roof to the top of the roof; roof orient corresponding to a binary variable indicating whether the roof's ridge (if it has one) runs parallel or perpendicular to the longest principle direction of the roof footprint; and/or the like.

In one implementation, the attribute prediction system 212 uses CNNs to predict all of these attributes. For example, the attribute prediction system 212 may use one CNN to predict the roof type and a second CNN to predict the remaining three attributes conditioned on the roof type (as the type of roof may influence how the CNN should interpret e.g. what amount of the observed height of the component is to the component mass vs. the roof geometry). In one example, these CNNs of the attribute prediction system 212 each take as input a 7-channel image consisting of the RGBDI aerial imagery (5 channels), a top-down depth rendering of the canvas (1 channel), and a binary mask highlighting the component currently being analyzed (1 channel). The roof type and parameter networks may use ResNet-18 and a ResNet-50 architectures, respectively. For the roof parameter network, the attribute prediction system 212 implements conditioning on roof type via featurewise linear modulation.

As described herein, the object modeling system 104 may continue to be trained in a variety of manners. For example, the object modeling system 104 can automatically detect when the predicted building output as the 3D model poorly matches the ground-truth geometry (as measured against the sensor data of the input imagery 200, rather than human annotations). In these cases, the object modeling system 104 may prompt a human annotator to intervene in the form of imitation learning, so that the inference network of the object modeling system 104 improves as it sees more human corrections. The object modeling system 104 may also exploit beam-search over the top-K most likely roof classifications for each part, and optimizing for best-fit the shape parameters of each roof type which are held constant to automatically explore a broader range of possible reconstructions for individual buildings and then select the best result. The outputs of the object modeling system 104 can be made “more procedural,” by finding higher-level parameters governing buildings. For example, when a predicted stage is well-represented by a known parametric primitive, or by a composition of such primitives, the object modeling system 104 can replace the non-parametric polygon with its parametric equivalent. Finally, where street-level and oblique-aerial data is available, reconstructed buildings may be refined by inferring facade-generating programs for each wall surface.

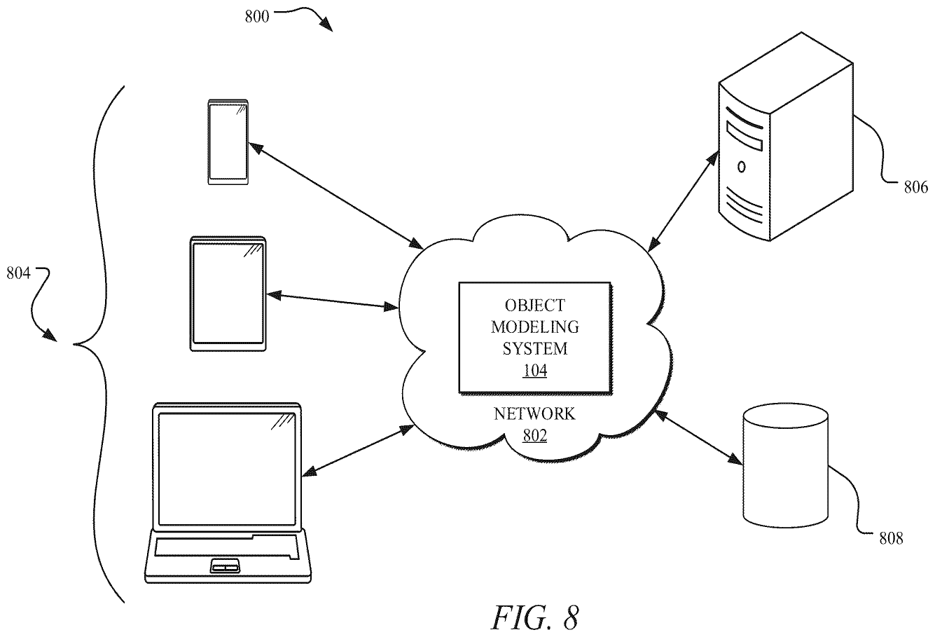

FIG. 8 illustrates an example network environment 800 for implementing the various systems and methods, as described herein. As depicted in FIG. 8, a network 802 is used by one or more computing or data storage devices for implementing the systems and methods for generating 3D models of real-world objects using the object modeling system 104. In one implementation, various components of the object inference system 100, one or more computing devices 804, one or more databases 808, and/or other network components or computing devices described herein are communicatively connected to the network 802. Examples of the computing devices 804 include a terminal, personal computer, a smart-phone, a tablet, a mobile computer, a workstation, and/or the like. The computing devices 804 may further include the imaging system 102 and the presentation system 106.

A server 806 hosts the system. In one implementation, the server 806 also hosts a website or an application that users may visit to access the system 100, including the object modeling system 104. The server 806 may be one single server, a plurality of servers with each such server being a physical server or a virtual machine, or a collection of both physical servers and virtual machines. In another implementation, a cloud hosts one or more components of the system. The object modeling system 104, the computing devices 804, the server 806, and other resources connected to the network 802 may access one or more additional servers for access to one or more websites, applications, web services interfaces, etc. that are used for object modeling, including 3D model generation of real world objects. In one implementation, the server 806 also hosts a search engine that the system uses for accessing and modifying information, including without limitation, the input imagery 200, 3D models of objects, the canvases 202, and/or other data.

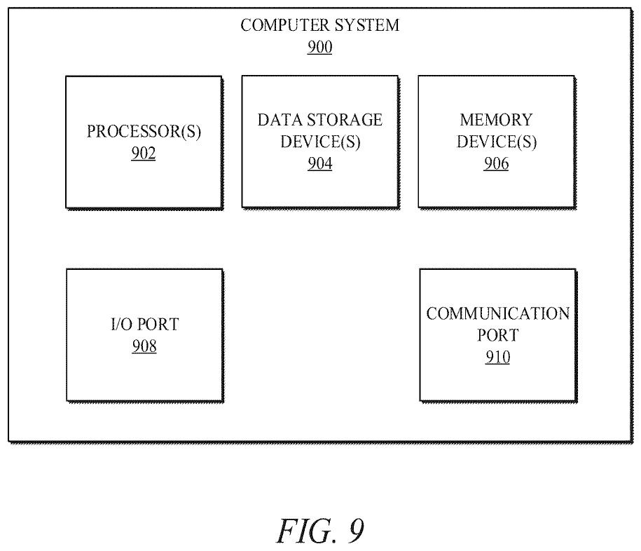

Referring to FIG. 9, a detailed description of an example computing system 900 having one or more computing units that may implement various systems and methods discussed herein is provided. The computing system 900 may be applicable to the imaging system 102, the object modeling system 104, the presentation system 106, the computing devices 804, the server 806, and other computing or network devices. It will be appreciated that specific implementations of these devices may be of differing possible specific computing architectures not all of which are specifically discussed herein but will be understood by those of ordinary skill in the art.

The computer system 900 may be a computing system is capable of executing a computer program product to execute a computer process. Data and program files may be input to the computer system 900, which reads the files and executes the programs therein. Some of the elements of the computer system 900 are shown in FIG. 9, including one or more hardware processors 902, one or more data storage devices 904, one or more memory devices 908, and/or one or more ports 908-910. Additionally, other elements that will be recognized by those skilled in the art may be included in the computing system 900 but are not explicitly depicted in FIG. 9 or discussed further herein. Various elements of the computer system 900 may communicate with one another by way of one or more communication buses, point-to-point communication paths, or other communication means not explicitly depicted in FIG. 9.

The processor 902 may include, for example, a central processing unit (CPU), a graphics processing unit (GPU), a microprocessor, a microcontroller, a digital signal processor (DSP), and/or one or more internal levels of cache. There may be one or more processors 902, such that the processor 902 comprises a single central-processing unit, or a plurality of processing units capable of executing instructions and performing operations in parallel with each other, commonly referred to as a parallel processing environment.

The computer system 900 may be a conventional computer, a distributed computer, or any other type of computer, such as one or more external computers made available via a cloud computing architecture. The presently described technology is optionally implemented in software stored on the data stored device(s) 904, stored on the memory device(s) 906, and/or communicated via one or more of the ports 908-910, thereby transforming the computer system 900 in FIG. 9 to a special purpose machine for implementing the operations described herein. Examples of the computer system 900 include personal computers, terminals, workstations, mobile phones, tablets, laptops, personal computers, multimedia consoles, gaming consoles, set top boxes, and the like.

The one or more data storage devices 904 may include any non-volatile data storage device capable of storing data generated or employed within the computing system 900, such as computer executable instructions for performing a computer process, which may include instructions of both application programs and an operating system (OS) that manages the various components of the computing system 900. The data storage devices 904 may include, without limitation, magnetic disk drives, optical disk drives, solid state drives (SSDs), flash drives, and the like. The data storage devices 904 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 906 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 904 and/or the memory devices 906, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 900 includes one or more ports, such as an input/output (I/O) port 908 and a communication port 910, for communicating with other computing, network, or vehicle devices. It will be appreciated that the ports 908-910 may be combined or separate and that more or fewer ports may be included in the computer system 900.

The I/O port 908 may be connected to an I/O device, or other device, by which information is input to or output from the computing system 900. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 900 via the I/O port 908. Similarly, the output devices may convert electrical signals received from computing system 900 via the I/O port 908 into signals that may be sensed as output by a human, such as sound, light, and/or touch. The input device may be an alphanumeric input device, including alphanumeric and other keys for communicating information and/or command selections to the processor 902 via the I/O port 908. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 900 via the I/O port 908. For example, an electrical signal generated within the computing system 900 may be converted to another type of signal, and/or vice-versa. In one implementation, the environment transducer devices sense characteristics or aspects of an environment local to or remote from the computing device 900, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 900, such as, physical movement of some object (e.g., a mechanical actuator), heating or cooling of a substance, adding a chemical substance, and/or the like.

In one implementation, a communication port 910 is connected to a network by way of which the computer system 900 may receive network data useful in executing the methods and systems set out herein as well as transmitting information and network configuration changes determined thereby. Stated differently, the communication port 910 connects the computer system 900 to one or more communication interface devices configured to transmit and/or receive information between the computing system 900 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 910 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 910 may communicate with an antenna or other link for electromagnetic signal transmission and/or reception.

In an example implementation, operations for generating 3D models of real-world objects and software and other modules and services may be embodied by instructions stored on the data storage devices 904 and/or the memory devices 906 and executed by the processor 902.

The system set forth in FIG. 9 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

1. A method for modeling an object, the method comprising:
receiving, at an object modeling system, imagery of an object captured by an imaging system from a single viewing angle;
determining, via the object modeling system, a first extruded polygon having a first geometry based on the imagery;
determining, via the object modeling system, a second extruded polygon having a second geometry based on the imagery and based on at least one first characteristic of the first geometry of the first extruded polygon, wherein the second geometry is different than the first geometry;
determining, via the object modeling system, a third extruded polygon having a third geometry based on the imagery and based on at least one second characteristic of the second geometry of the second extruded polygon, wherein the third geometry is different than the first geometry, the second geometry, or both;
generating, via the object modeling system, a three-dimensional (3D) model of the object based on the first extruded polygon, the second extruded polygon against the first extruded polygon, and the third extruded polygon against the second extruded polygon; and
outputting the 3D model of the object, a refined 3D model of the object, or both from the object modeling system to a presentation system.

2. The method of claim 1, comprising:
determining, via the object modeling system, a first height and a first shape corresponding to the first geometry of the first extruded polygon based on the imagery;
determining, via the object modeling system, a second height and a second shape corresponding to the second geometry of the second extruded polygon based on the imagery and based on the at least one first characteristic of the first geometry of the first extruded polygon; and
determining, via the object modeling system, a third height and a third shape corresponding to the third geometry of the third extruded polygon based on the imagery and based on the at least one second characteristic of the second geometry of the second extruded polygon.

3. The method of claim 1, comprising:
generating, via the object modeling system, the refined 3D model of the object based on the 3D model of the object and based on additional imagery captured by the imaging system, an additional imaging system, or both from an additional viewing angle different than the single viewing angle; and
outputting the refined 3D model of the object from the object modeling system to the presentation system.

4. The method of claim 1, comprising:
determining, via the object modeling system, a roof component corresponding to a roof of the object based on the imagery and based on at least one convolutional neural network (CNN); and
generating, via the object modeling system, the 3D model of the object based on the first extruded polygon, the second extruded polygon atop the first extruded polygon, the third extruded polygon atop the second extruded polygon, and the roof component atop the third extruded polygon or a fourth extruded polygon.

5. The method of claim 4, comprising:
determining, via the object modeling system, a roof type of the roof component based on the imagery and based on a first CNN of the at least one CNN; and
determining, via the object modeling system, at least one additional roof attribute of the roof component based on the imagery and based on a second CNN conditioned on the roof type.

6. The method of claim 5, wherein the at least one additional roof attribute of the roof component comprises a roof height and a roof orient.

7. The method of claim 1, wherein the first extruded polygon corresponds to a base layer of the object, the second extruded polygon corresponds to an intermediate layer of the object, and the third extruded polygon corresponds to an additional intermediate layer of the object or a top layer of the object.

8. The method of claim 1, comprising performing, via the object modeling system, an iterative process comprising a plurality of stages corresponding to a plurality of extruded polygons of the 3D model of the object, wherein the iterative process comprises:
a first stage of the plurality of stages, the first stage comprising:
determining, based on the imagery, a first raster mask corresponding to a first stage component of the first stage; and
converting the first raster mask into the first extruded polygon of the plurality of extruded polygons;
a second stage of the plurality of stages, the second stage comprising:
determining, based on the imagery and the first characteristic, a second raster mask corresponding to a second stage component of the second stage; and
converting the second raster mask into a second extruded polygon of the plurality of extruded polygons; and
a third stage of the plurality of stages, the third stage comprising:
determining, based on the imagery and the second characteristic, a third raster mask corresponding to a third stage component of the third stage; and
converting the third raster mask into a third extruded polygon of the plurality of extruded polygons.

9. The method of claim 8, wherein:
the first stage comprises converting the first raster mask into the first extruded polygon via a first vectorization process;
the second stage comprises converting the second raster mask into the second extruded polygon via a second vectorization process; and
the third stage comprises converting the third raster mask into the third extruded polygon via a third vectorization process.

10. The method of claim 8, wherein:
the second stage comprises determining, based on the imagery, a convolutional image-to-image translation network, and the first characteristic, the second raster mask corresponding to the second stage component of the second stage; and
the third stage comprises determining, based on the imagery, the convolutional image-to-image translation network, and the second characteristic, the third raster mask corresponding to the third stage component of the third stage.

11. The method of claim 8, comprising determining, via a convolutional neural network (CNN) consulted by a termination system at each stage of the plurality of stages of the iterative process, whether to terminate the iterative process based on the 3D model completing a representation of the object.

12. A method for modeling an object, comprising:
receiving, at an object modeling system, imagery of an object captured by an imaging system from a single viewing angle;
performing, via the object modeling system, an iterative process comprising a plurality of stages corresponding to a plurality of extruded polygons of a three-dimensional (3D) model of the object, wherein the iterative process comprises:
a first stage of the plurality of stages, the first stage comprising:
determining, based on the imagery, a first raster mask corresponding to a first stage component of the first stage; and
converting, via a first vectorization process, the first raster mask into a first extruded polygon of the plurality of extruded polygons, the first extruded polygon having a first geometry;
a second stage of the plurality of stages, the second stage comprising:
determining, based on the imagery, a convolutional image-to-image translation network, and a first characteristic of the first stage, a second raster mask corresponding to a second stage component of the second stage; and
converting, via a second vectorization process, the second raster mask into a second extruded polygon of the plurality of extruded polygons, the second extruded polygon having a second geometry different than the first geometry; and
a third stage of the plurality of stages, the third stage comprising:
determining, based on the imagery, the convolutional image-to-image translation network, and a second characteristic of the second stage, a third raster mask corresponding to a third stage component of the third stage; and
converting, via a third vectorization process, the third raster mask into a third extruded polygon of the plurality of extruded polygons, the third extruded polygon having a third geometry different than the first geometry, the second geometry, or both;
generating, via the object modeling system, the 3D model of the object based on the first extruded polygon, the second extruded polygon against the first extruded polygon, and the third extruded polygon against the second extruded polygon; and
outputting the 3D model of the object, a refined 3D model of the object, or both from the object modeling system to a presentation system.

13. The method of claim 12, wherein:
the first geometry of the first extruded polygon comprises a first height and a first shape;
the second geometry of the second extruded polygon comprises a second height and a second shape; and
the third geometry of the third extruded polygon comprises a third height and a third shape.

14. The method of claim 12, comprising:
generating, via the object modeling system, the refined 3D model of the object based on the 3D model of the object and based on additional imagery captured by the imaging system, an additional imaging system, or both from an additional viewing angle different than the single viewing angle; and
outputting the refined 3D model of the object from the object modeling system to the presentation system.

15. The method of claim 12, comprising:
determining, via the object modeling system, a roof component corresponding to a roof of the object based on the imagery and based on at least one convolutional neural network (CNN); and
generating, via the object modeling system, the 3D model of the object based on the first extruded polygon, the second extruded polygon atop the first extruded polygon, the third extruded polygon atop the second extruded polygon, and the roof component atop the third extruded polygon or a fourth extruded polygon.

16. The method of claim 15, comprising:
determining, via the object modeling system, a roof type of the roof component corresponding to the roof of the object based on the imagery and based on a first CNN of the at least one CNN; and
determining, via the object modeling system, at least one additional roof attribute of the roof component corresponding to the roof of the object based on the imagery and based on a second CNN conditioned on the roof type.

17. The method of claim 16, wherein the at least one additional roof attribute of the roof component comprises a roof height and a roof orient.

18. The method of claim 12, wherein the first extruded polygon corresponds to a base layer of the object, the second extruded polygon corresponds to an intermediate layer of the object, and the third extruded polygon corresponds to an additional intermediate layer of the object or a top layer of the object.

19. The method of claim 12, comprising determining, via a termination system and at each stage of the plurality of stages of the iterative process, whether to terminate the iterative process based on the 3D model completing a representation of the object.

20. The method of claim 19, comprising determining, via a convolutional neural network (CNN) consulted by the termination system at each stage of the plurality of stages of the iterative process, whether to terminate the iterative process based on the 3D model completing the representation of the object.
